(19) United States
(12) Patent Application Publication
(10) Pub. No.: US 2025/0158188 A1
(43) Pub. Date: May 15, 2025

(54) ENERGY STORAGE APPARATUS

(71) Applicant: Jinko Energy Storage Technology Co., Ltd., Haining (CN)

(72) Inventors: Xiang WANG, Haining (CN); Guochao CHEN, Haining (CN)

(21) Appl. No.: 18/757,427

(22) Filed: Jun. 27, 2024

(30) Foreign Application Priority Data
Nov. 9, 2023 (CN) 202311497885.6
Nov. 9, 2023 (CN) 202323031809.4
Nov. 9, 2023 (CN) 202323035518.2

(51) Int. Cl. H01M 50/209; H01M 10/42; H01M 10/613; H01M 10/6552; H01M 50/222; H01M 50/224; H01M 50/24; H01M 50/298

(52) U.S. Cl. CPC H01M 50/209; H01M 10/425; H01M 10/613; H01M 10/6552; H01M 50/222; H01M 50/224; H01M 50/24; H01M 50/298; H01M 2010/4278

(57) ABSTRACT

Energy storage apparatus is provided, which includes box, battery pack, and battery rack. Battery pack is mounted in box. Along first direction, two sides of battery pack are provided with guide groove. Battery rack is configured to place battery pack and includes rack body and support member, two sides of rack body are connected to support members. Support member includes side plate and bottom plate fixedly connected to each other, bottom plate is configured to support battery pack, side plate is provided with guide portion, and when battery pack moves along second direction on bottom plate, guide portion extends into guide groove to limit movement of battery pack in first direction. Second direction is perpendicular to first direction. Two guide portions located on two sides of battery pack cooperate to ensure battery pack is always at centered position and battery pack is mounted and placed accurately, stably, and efficiently.

### CROSS-REFERENCE TO RELATED APPLICATIONS

The present application claims priority to Chinese Patent Application No. 202311497885.6, filed on Nov. 9, 2023; Chinese Patent Application No. 202323031809.4, filed on Nov. 9, 2023; Chinese Patent Application No. 202323035518.2, filed on Nov. 9 2023; the content of which are incorporated herein by reference in its entirety.

### TECHNICAL FIELD

The present disclosure relates to the technical field of energy storage batteries, and in particular, to an energy storage apparatus.

### BACKGROUND

An energy storage apparatus is a highly integrated device, which is mainly applied to energy storage apparatuses and integrates a battery pack, a battery management system (BMS), an energy management system (EMS), a power conversion system (PCS), and other electrical devices. A battery rack is generally arranged inside the energy storage apparatus. A plurality of battery packs are neatly placed on the battery rack.

Due to a heavy weight, the battery pack is required to be mechanically hoisted to a corresponding height and then pushed into the battery rack along a horizontal direction to complete the mounting. However, the battery rack in the prior art does not have a guide structure. When the battery pack is pushed into the battery rack, the battery pack is easily incorrectly positioned and cannot be mounted in place.

### SUMMARY

The present disclosure provides an energy storage apparatus, which can solve the problem of inconvenient mounting of the battery pack in the prior art.

The present disclosure provides an energy storage apparatus, including a box, a battery pack, and a battery rack, wherein the battery pack is mounted in the box, and along a first direction, two sides of the battery pack are each provided with a guide groove; the battery rack is configured to place the battery pack, the battery rack includes a rack body and a support member, and along the first direction, two sides of the rack body are connected to the support members respectively; wherein the support member includes a side plate and a bottom plate fixedly connected to each other, the bottom plate is configured to support the battery pack, the side plate is provided with a guide portion, and when the battery pack moves along a second direction on the bottom plate, at least part of the guide portion is capable of extending into the guide groove to limit movement of the battery pack in the first direction; and the second direction is perpendicular to the first direction.

In a possible design, the support member includes a first end and a second end oppositely arranged along the second direction, and along a direction from the first end to the second end, the guide portion includes a guide section and a limiting section arranged in sequence; and along the direction from the first end to the second end, a dimension of the guide section in the first direction gradually increases.

In a possible design, along the first direction, a side of the guide section away from the side plate is provided with a guide slope, and an angle α is formed between an extension direction of the guide slope and the first direction, where 20°≤α≤30°; and/or along the first direction, a width of the limiting section is W1, where 2 cm≤W1≤2.5 cm.

In a possible design, the guide portion includes a first guide portion and a second guide portion, the first guide portion and the second guide portion being spaced apart along the second direction.

In a possible design, along the second direction, a distance between the first guide portion and the second guide portion is L1, where 50 cm≤L1≤55 cm; and/or along the second direction, a length of the first guide portion is L2, where 9 cm≤L2≤11 cm; and/or along the second direction, a length of the second guide portion is L3, where 5 cm≤L3≤36 cm.

In a possible design, along the direction from the first end to the second end, the first guide portion includes a first section and a second section arranged in sequence, the first section being the guide section, and the second section being the limiting section; a dimension of the first section in the second direction is LA, and a dimension of the second section in the second direction is L5, where 0.16≤L4:L5≤0.38; and/or along the direction from the first end to the second end, the second guide portion includes a third section and a fourth section arranged in sequence, the third section being the guide section, and the fourth section being the limiting section; and a dimension of the third section in the second direction is L6, and a dimension of the fourth section in the second direction is L7, where 0.33≤L6:L7≤1.

In a possible design, the support member further includes a limiting plate extending along a third direction, the limiting plate being located at the second end, and the limiting plate being fixedly connected to both the bottom plate and the side plate; and the third direction is perpendicular to the first direction and the second direction.

In a possible design, the rack body includes a longitudinal beam extending along the third direction, and the side plate is fixedly connected to the longitudinal beam; and along the third direction, a plurality of support members are spaced apart on the longitudinal beam; and the longitudinal beam is provided with an insertion hole, the side plate is provided with a plug-in portion, and at least part of the plug-in portion is capable of extending into the insertion hole, to limit movement of the support member along the third direction and/or the second direction.

In a possible design, the box has a battery compartment, a high-voltage compartment, and a partition, the partition being located between the battery compartment and the high-voltage compartment, the partition having a first drain outlet, the first drain outlet being in communication with the battery compartment and the high-voltage compartment, the high-voltage compartment having a connecting pipe, the connecting pipe being in communication with the first drain outlet, a bottom wall of the high-voltage compartment having a second drain outlet, and the second drain outlet being in communication with the outside.

In a possible design, the second drain outlet has a closing valve, the closing valve being detachably mounted on the second drain outlet.

In a possible design, the partition is made of a sheet and a core, the core is located between two sheets, the sheet is metal, and the core is rock wool.

In a possible design, the energy storage apparatus has a plurality of cabinet doors, the plurality of cabinet doors being rotatably fixed to the box, the cabinet doors being configured to close the battery compartment and the high-voltage compartment, each of the cabinet doors being provided with a door lifter at the bottom, and the door lifter having a guide surface.

In a possible design, the cabinet door has a hook, the hook having a hanging hole, the hanging hole being capable of fitting a hanging rod to limit closing of the cabinet door.

In a possible design, the energy storage apparatus includes a plurality of liquid sensors, the plurality of liquid sensors being respectively mounted on the partition and the bottom wall of the high-voltage compartment; and the liquid sensors in the high-voltage compartment are located between the connecting pipe and the second drain outlet.

In a possible design, an inner wall of the high-voltage compartment has a plurality of high-voltage box frames, the plurality of high-voltage box frames being respectively located on two sides of the high-voltage compartment, the high-voltage box frames being not in contact with the bottom wall of the high-voltage compartment, and the high-voltage box frames being configured to mount a high-voltage box.

In a possible design, the box has a battery compartment, a high-voltage compartment, and a partition, the partition being located between the battery compartment and the high-voltage compartment; the partition being provided with a fireproof member, the fireproof member being provided with a communication hole, a wire harness and/or a pipeline of the battery compartment being capable of extending into the high-voltage compartment through the communication hole.

In a possible design, the communication hole includes a first through hole, a second through hole, and a third through hole, the first through hole being configured to allow a liquid cooling pipeline to pass through, the second through hole being configured to allow a communication wire harness to pass through, and the third through hole being configured to allow a power wire harness to pass through.

In a possible design, centers of the first through hole, the second through hole, and the third through hole are not in a straight line.

In a possible design, the fireproof member includes a plurality of plates, the plates being provided with grooves, and when the plurality of plates are spliced, the grooves being enclosed to form the communication hole.

In a possible design, the fireproof member includes a first plate and a second plate, the first plate and the second plate being each provided with a protruding portion, the protruding portion being provided with a first mounting hole; and when the first plate and the second plate are spliced, the two protruding portions abutting against each other, and a first connecting member passing through the two first mounting holes.

In the present disclosure, the side plate is provided with the guide portion, and when the battery pack is offset along the first direction, the guide portion can abut against the inner wall of the guide groove, so that the battery pack is pushed back to the correct position. Therefore, the two guide portions located on the two sides of the battery pack along the first direction can cooperate to ensure that the battery pack is always at a relatively centered position in the first direction and the battery pack can be mounted and placed accurately, stably, and efficiently. Moreover, when the battery pack is always at a relatively centered position in the first direction, there is a certain amount of space left on the two sides thereof, which is also convenient for the staff to connect and maintain pipelines. The battery rack and the battery pack are generally mounted in a factory to form a complete energy storage apparatus and then transported as a whole. During the transportation of the energy storage apparatus, the guide portion can further limit movement of the battery pack in the first direction and the third direction, thereby preventing significant shaking of the battery pack on the battery rack and ensuring stability of the mounting of the battery pack. Besides, the bottom plate can be configured to support the battery pack placed on a surface thereof, and can also be configured to limit movement of another battery pack located therebelow in the third direction, further improving the stability of the battery pack.

It should be understood that the general description above and the detailed description in the following are merely exemplary, and cannot limit the present disclosure.

### BRIEF DESCRIPTION OF DRAWINGS

FIG. 1 is a schematic structural diagram of an energy storage apparatus according to the present disclosure;

FIG. 2 is a schematic diagram of an internal structure of the energy storage apparatus in FIG. 1;

FIG. 3 is a schematic diagram of assembly of a battery rack and a battery pack in FIG. 1;

FIG. 4 is a schematic structural diagram of a support member in FIG. 3;

FIG. 5 is a schematic structural diagram of the battery pack in FIG. 1;

FIG. 6 is a schematic structural diagram of Part A in FIG. 4;

FIG. 7 is a schematic structural diagram of Part B in FIG. 4;

FIG. 8 is a schematic structural diagram of a battery rack in FIG. 2;

FIG. 9 is a schematic structural diagram of the battery rack in FIG. 8 from another perspective;

FIG. 10 is an enlarged view of Part C in FIG. 9;

FIG. 11 is a schematic structural diagram of a first drain outlet and a second drain outlet according to the present disclosure;

FIG. 12 is a schematic structural diagram of the second drain outlet according to the present disclosure;

FIG. 13 is a schematic structural diagram of a closing valve according to some embodiments of the present disclosure;

FIG. 14 is a partial enlarged view of Part A in FIG. 2;

FIG. 15 is a partial enlarged view of Part B in FIG. 2;

FIG. 16 is a partial enlarged view of a part between a battery compartment and a high-voltage compartment in FIG. 1; and

FIG. 17 is a schematic structural diagram of a fireproof member in FIG. 16.

### REFERENCE SIGNS

10: box;
   101: device compartment;
   102: battery compartment;
   103: high-voltage compartment;
      103a: second drain outlet;
      103b: connecting pipe;
      103c: closing valve;
   104: partition;
      104a: first drain outlet;
   105: cabinet door;
      105a: door lifter;
      105b: hook;
20: battery pack;
   201: guide groove;
30: battery rack;
40: high-voltage box;
1: rack body;
   11: longitudinal beam;
      111: insertion hole;
2: support member;
   21: side plate;
      211: plug-in portion;
      212: gap;
   22: bottom plate;
   23: guide portion;
      231: first guide portion;
         231a: first section;
         231b: second section;
      232: second guide portion;
         232a: third section;
         232b: fourth section;
      233: guide slope;
   24: first end;
   25: second end;
   26: first bending portion;
   27: limiting plate;
   28: second bending portion;
3: reinforcing member;
4: fireproof member;
   41: communication hole;
      411: first through hole;
      412: second through hole;
      413: third through hole;
   42: sealing member;
   43: protruding portion;
      431: first mounting hole;
   44: second mounting hole;
5: liquid sensor.

The accompanying drawings herein, which are incorporated in and constitute a part of this specification, illustrate embodiments consistent with the present disclosure and, together with the specification, serve to explain principles of the present disclosure.

### DESCRIPTION OF EMBODIMENTS

In order to better understand the technical solution of the present disclosure, some embodiments of the present disclosure will be described in detail below with reference to the accompanying drawings.

It should be clear that the described embodiments are only some of rather than all of the embodiments of the present disclosure. Based on the embodiments in the present disclosure, all other embodiments obtained by those of ordinary skill in the art without creative efforts fall within the protection scope of the present disclosure.

The terms used in the embodiments of the present disclosure are only for the purpose of describing specific embodiments and are not intended to limit the present disclosure. As used in the embodiments of the present disclosure and the appended claims, the singular forms of “a/an”, “one”, and “the” are intended to include plural forms, unless otherwise clearly specified in the context.

It should be understood that the term “and/or” describes an association relationship between associated objects and represents that three relationships may exist. For example, A and/or B may represent the following three cases: only A exists, both A and B exist, and only B exists. In addition, the character “/” generally indicates an “or” relationship between the associated objects.

It should be noted that orientation terms such as “upper”, “lower”, “left”, and “right” described in the embodiments of the present disclosure are described from the perspective shown in the drawings and should not be understood as limiting the embodiments of the present disclosure. Additionally, it should be understood in the context that when an element is referred to as being connected “on” or “under” another element, the element can not only be directly connected “on” or “under” the another element, but also can be directly connected “on” or “under” the another element, or may be indirectly connected “on” or “under” the another element through an intermediate element.

An energy storage apparatus is featured with simplified infrastructure construction costs, a short construction cycle, a high degree of modularity, easy transportation, and mounting, and can be applied to thermal, wind, solar and other power stations or in applications such as islands, communities, schools, scientific research institutions, factories, and large load centers.

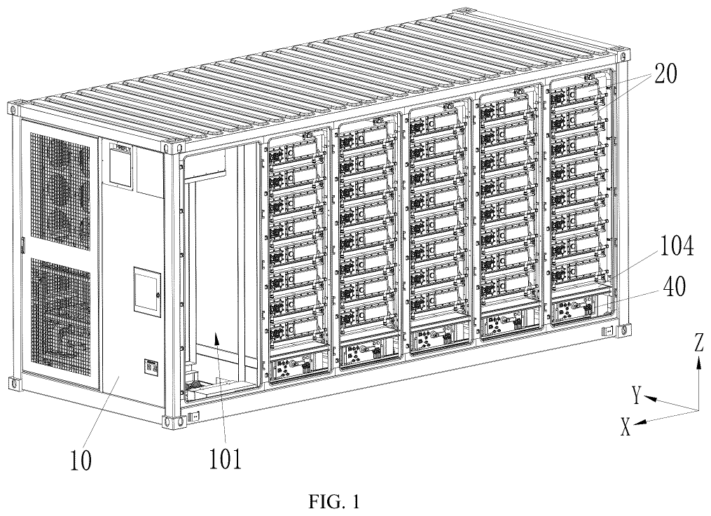

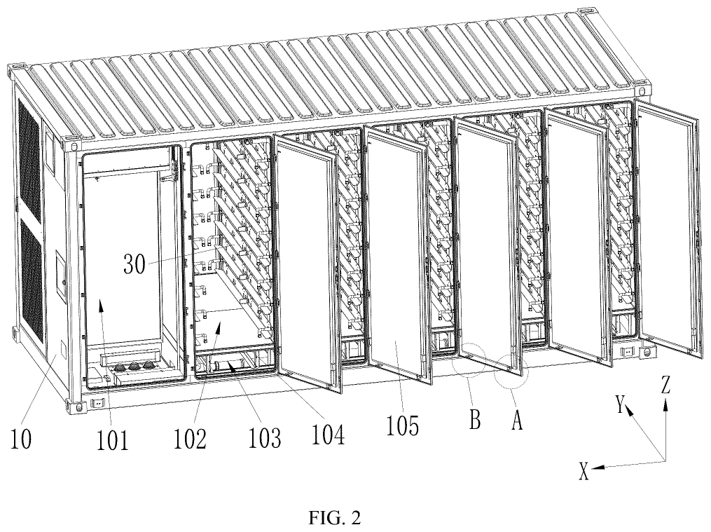

Some embodiments of the present disclosure provide an energy storage apparatus. As shown in FIG. 1 and FIG. 2, the energy storage apparatus includes a box 10. The box 10 is provided with two relatively independent spaces: a device compartment 101 and a battery compartment 102. The device compartment 101 may be configured to place PCS and EMS control cabinets. A PCS may control charging and discharging processes, perform AC and DC conversion, and directly power an AC load when there is no power grid. An EMS mainly collects a real-time power state of a power grid through communication with a smart meter and detects changes in load power in real time. In addition, other related devices may also be placed in the device compartment 101, which is not limited in the present disclosure.

To facilitate the description of a structure of the energy storage apparatus, a length direction of the box 10 is defined as a first direction X, a width direction of the box 10 is defined as a second direction Y, and a height direction of the box 10 is defined as a third direction Z. The first direction X, the second direction Y, and the third direction Z are pairwise perpendicular.

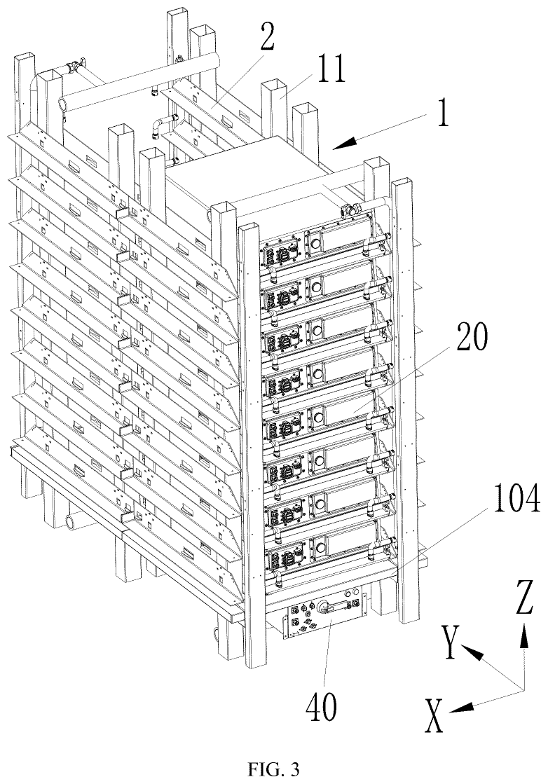

The battery compartment 102 is provided with a battery pack 20 and a battery rack 30 configured to place the battery pack 20. As shown in FIG. 3, the battery rack 30 includes a rack body 1 and a support member 2, the rack body 1 includes a longitudinal beam 11 extending along the third direction Z, along the first direction X, the longitudinal beams 11 on two sides of the rack body 1 are connected with support members 2, and the two support members 2 located at a same height in the third direction Z are configured to store a same battery pack 20. According to a specific number of battery packs 20, the battery rack 30 may be provided with a plurality of support members 2 spaced apart in the third direction Z to separate the battery rack 30, thereby realizing three-dimensional storage of a plurality of battery packs 20 in the battery compartment 102, and improving space utilization within the energy storage apparatus.

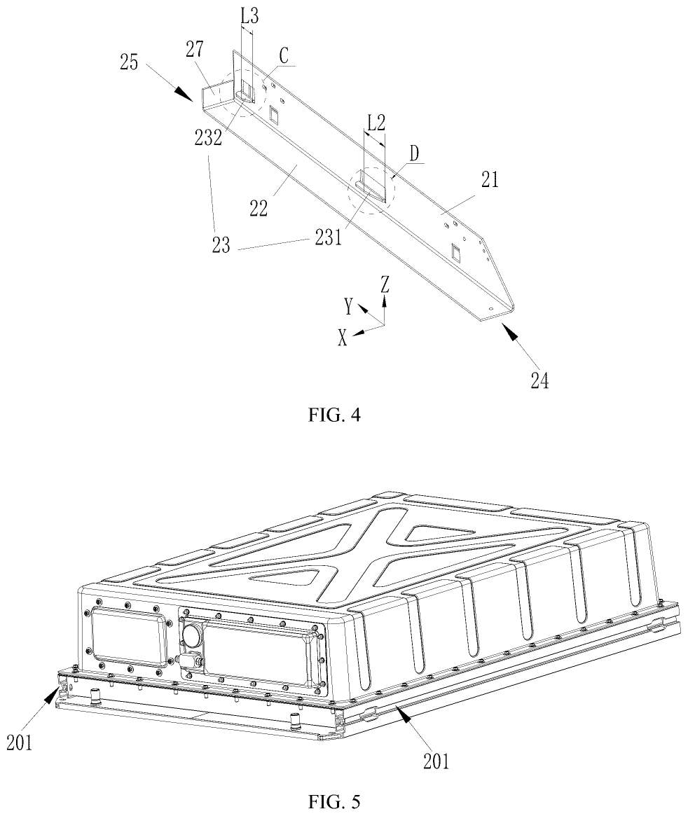

As shown in FIG. 4, each support member 2 includes a side plate 21 and a bottom plate 22 fixedly connected to each other. The bottom plate 22 is configured to support the battery pack 20 to store the battery pack 20. The side plate 21 is configured to be fixedly connected to the longitudinal beam 11. The side plate 21 is provided with a guide portion 23 extending along the first direction X relative to the side plate 21. Correspondingly, as shown in FIG. 5, along the first direction X, two sides of the battery pack 20 are each provided with a guide groove 201 concave towards the interior of the battery pack 20. When the battery pack 20 moves along the second direction Y on the bottom plate 22, at least part of the guide portion 23 can extend into the guide groove 201 to limit movement of the battery pack 20 in the first direction X.

In this embodiment, due to a large weight, the battery pack 20 is required to be lifted by a hoisting device along the third direction Z to a height corresponding to the support member 2 to make the bottom of the battery pack 20 overlap with the bottom plate 22, and then the battery pack 20 is manually or mechanically pushed horizontally into the battery rack 1 along the second direction Y (that is, the battery pack 20 slides on the bottom plate 22 along the second direction Y) to realize the storage of the battery pack 20. During the sliding of the battery pack 20 along the second direction Y, the guide portions 23 located on the two sides of the battery pack 20 can respectively extend into the guide grooves 201 on the two sides of the battery pack 20 to jointly limit the movement of the battery pack 20 in the first direction X to ensure that the battery pack 20 can be stably pushed into the battery rack 30, thereby improving mounting efficiency of the battery pack 20.

If the side plate 21 is not provided with the guide portion 23, during the sliding along the second direction Y, the battery pack 20 is easily offset along the first direction X. As a result, the battery pack 20 interferes with the side plate 21 and cannot be continuously pushed into the battery rack 30 along the second direction X. In this case, there is a need to manually adjust the position of the battery pack 20 and then continue the pushing, which is time-consuming and labor-intensive, affects the mounting efficiency of the battery pack 20, and may also cause wear of the battery pack 20 and the support member 2, thereby affecting the service life of the battery rack 30 and the battery pack 20 and posing certain safety risks.

According to the support member 2 provided in the present disclosure, the side plate 21 is provided with the guide portion 23, and when the battery pack 20 is offset along the first direction X, the guide portion 23 can abut against the inner wall of the guide groove 201, so that the battery pack 20 is pushed back to the correct position. Therefore, the two guide portions 23 located on the two sides of the battery pack 20 along the first direction X can cooperate to ensure that the battery pack 20 is always at a relatively centered position in the first direction X and the battery pack 20 can be mounted and placed accurately, stably, and efficiently. Moreover, when the battery pack 20 is always at a relatively centered position in the first direction X, there is a certain amount of space left on the two sides thereof, which is also convenient for the staff to connect and maintain pipelines.

The battery rack 30 and the battery pack 20 are generally mounted in a factory to form a complete energy storage apparatus and then transported as a whole. During the transportation of the energy storage apparatus, the guide portion 23 can further limit movement of the battery pack 20 in the first direction X and the third direction Z, thereby preventing significant shaking of the battery pack 20 on the battery rack 30 and ensuring stability of the mounting of the battery pack 20. Besides, the bottom plate 22 can be configured to support the battery pack 20 placed on a surface thereof, and can also be configured to limit movement of another battery pack 20 located therebelow in the third direction Z, further improving the stability of the battery pack 20.

In addition, as shown in FIG. 3, alternatively, two battery racks 30 may be placed back-to-back along the second direction Y to realize double-row storage of the battery packs 20, and then cabinet doors 105 are provided on two sides of the box 10 along the second direction X to facilitate the staff to manage the battery packs 20 on the two sides.

As shown in FIG. 4, the battery compartment 102 is further provided with a high-voltage box 40. The high-voltage box 40 is configured to connect the battery pack 30 and the PCS, which is a management unit of the battery pack, provides charge and discharge control for the battery pack, provides power-on control for an external high-voltage component, and is responsible for collecting a voltage, a current, a temperature, and other information of batteries in the battery pack and packaging and uploading the information to implement functions such as battery overload and short-circuit protection, high-voltage sampling, and low-voltage control, and protect and monitor operation of a high-voltage system. When a plurality of battery packs 20 are placed in the battery compartment 102, the plurality of battery packs 20 arranged along the third direction Z form a battery cluster (generally, a plurality of battery packs 20 placed on a same battery rack 30 form a battery cluster). All battery packs 20 of each battery cluster are connected to a same high-voltage box 40. The high-voltage box 40 aggregates energy of all the battery packs 20 in the battery cluster to the PCS, and is configured to distribute energy of the PCS to each battery pack 20.

It is to be noted that the first direction X, the second direction Y, and the third direction Z in the present disclosure are pairwise perpendicular. For example, the first direction X may be a width direction of the battery rack 30, the second direction Y may be a depth direction of the battery rack 30, and the third direction Z may be a height direction of the battery rack 30.

As shown in FIG. 2, during daily operation of the energy storage apparatus, the cabinet door 105 is in a closed state and has functions of heat insulation and fire prevention. When maintenance is required, the cabinet door 105 is opened. As shown in FIG. 4, the support member 2 includes a first end 24 and a second end 25 oppositely arranged along the second direction Y. The first end 24 is an end of the support member 2 close to the cabinet door 105, and the second end 25 is an end of the support member 2 away from the cabinet door 105.

In some embodiments, along a direction from the first end 24 to the second end 25, the guide portion 23 includes a guide section and a limiting section arranged in sequence, and a dimension of the guide section in the first direction X gradually increases. Along the first direction X, a side of the guide section away from the side plate 21 (that is, a side close to the battery pack) is provided with a guide slope 233. Under this structure, when the battery pack 20 is pushed into the battery rack 30, the guide section first extends into the guide groove 201, and the battery pack 20 fits the guide section. Once the battery pack 20 is offset along the first direction X towards the side plate 21 on a certain side, the battery pack 20 can abut against the guide slope 233 of the guide portion 23 on the side. In this case, the battery pack 20 can be continuously pushed inward so as to slide along the guide slope 233. Since the dimension of the guide section gradually increases in the first direction X, the battery pack 20 can be pushed back to a relatively centered position along the first direction X under guidance of the guide slope. During the continuous movement of the battery pack 20 along the second direction Y, the two limiting sections located on the two sides of the battery pack 20 along the first direction X can respectively extend into the guide grooves 201 on the two sides of the battery pack 20. Once the battery pack 20 is offset along the first direction X towards the side plate 21 on a certain side, the limiting section can abut against the side wall of the guide groove 201 to prevent continuous movement of the battery pack 20 along the first direction X, thereby ensuring that the battery pack 20 is always at a relatively centered position in the first direction X. Therefore, when the guide portion 23 adopts the above structure, the battery pack 20 may be guided and limited, and the position can be adjusted without pulling the battery pack 20 out from the battery rack 30, which helps improve the mounting efficiency of the battery pack 20.

For example, a dimension of the limiting section in the first direction X may be equal to a maximum dimension of the guide section in the first direction X. That is, there is no obvious dividing line between the limiting section and the guide section, and transition between the two is relatively smooth, which can also prevent edges and corners in the structure of the guide portion 23 and protect bumping of the battery pack 20.

In some embodiments, as shown in FIG. 4, the guide portion 23 includes a first guide portion 231 and a second guide portion 232, and the first guide portion 231 and the second guide portion 232 are spaced apart along the second direction Y. Along the direction from the first end 24 to the second end 25, the first guide portion 231 includes a first section 231a and a second section 231b arranged in sequence, and the second guide portion 232 includes a third section 232a and a fourth section 232b arranged in sequence. The first section 231a and the third section 232a are guide sections, and the second section 231b and the fourth section 232b are limiting sections.

In such embodiments, the first guide portion 231 and the second guide portion 232 are spaced apart along the second direction Y, which can achieve secondary guiding and double limiting effects on the battery pack 20, making the mounting of the battery pack 20 more efficient and labor-saving. The second section 231b and the fourth section 232b are limited at the same time, which can further improve the mounting stability of the battery pack 20. In addition, even if one of the first guide portion 231 and the second guide portion 232 is damaged and falls off, the other can continuously ensure the guiding and limiting effects of the guide portion 23, thereby improving reliability of the guide portion 23.

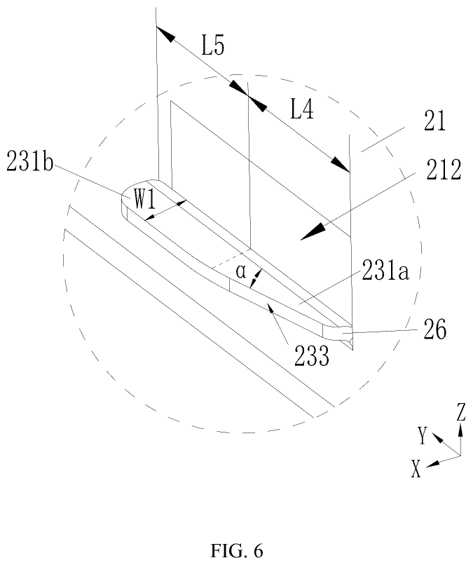

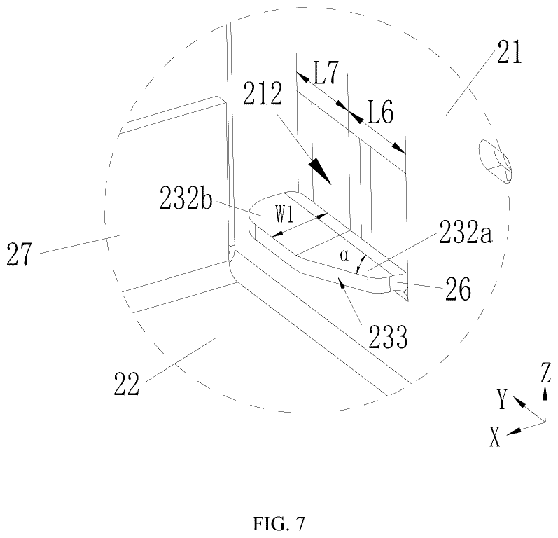

For example, as shown in FIG. 6 and FIG. 7, when pushed into the battery rack 30, the battery pack 20 can fit the first guide portion 231, the first section 231a guides the battery pack 20 to ensure that the battery pack 20 is always at a relatively centered position in the first direction X, and then the second section 231b limits the battery pack 20 in the first direction X. The battery pack 20 continuously moves along the second direction Y and can also fit the second guide portion 232, and the third section 232a guides the battery pack 20 to achieve the secondary guiding effect of the support member 2. Then, the fourth section 232b limits the position of the battery pack 20 in the first direction X, that is, the second section 231b and the fourth section 232b limit the position of the battery pack 20 at the same time, further improving the guiding and limiting effects of the guide portion 23.

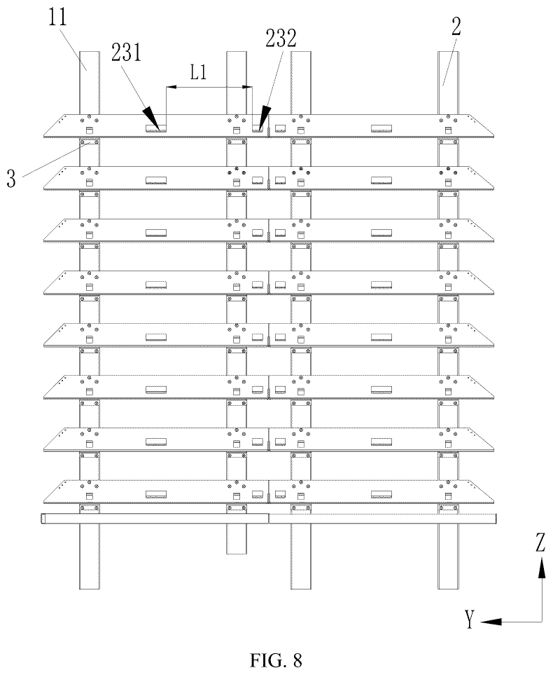

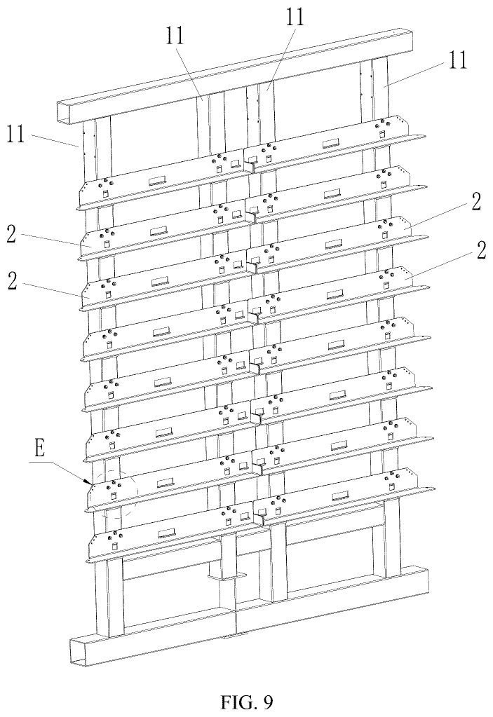

In some embodiments, as shown in FIG. 8, along the second direction Y, a distance between the first guide portion 231 and the second guide portion 232 is L1, where 50 cm≤L1≤55 cm, which may be, for example, 50 cm, 50.5 cm, 51 cm, 51.5 cm, 52 cm, 52.5 cm, 53 cm, 53.5 cm, 54 cm, 54.5 cm, or 55 cm, or may be other values in the above range. This is not limited in the present disclosure.

If L1 is excessively small (e.g., less than 50 cm), positions of the first guide portion 231 and the second guide portion 232 are excessively close, the battery pack 20 is already at a centered position along the first direction X under the action of the second section 231b and can continuously be maintained at the centered position under the action of the fourth section 232b before being offset. As a result, the second guide portion 232 cannot achieve the secondary guiding effect. If L1 is excessively large (e.g., greater than 55 cm), the distance between the first guide portion 231 and the second guide portion 232 is excessively large, and a length of the support member 2 may also increase, which may cause the battery rack 30 to occupy an excessively large volume and not match the size of the box 10.

Therefore, when the distance L1 between the first guide portion 231 and the second guide portion 232 ranges from 50 cm to 55 cm, the secondary guiding effect of the second guide portion 232 can be achieved, and the volume of the battery rack 30 can be appropriately reduced, so that the battery rack can match sizes of most boxes 10 on the market.

In some embodiments, since the first guide portion 231 first fits the battery pack 20, a length L2 thereof in the second direction Y is required to be slightly larger to ensure that the first guide portion 231 has good guiding and limiting effects on the battery pack 20.

For example, as shown in FIG. 44, along the second direction Y, a length of the first guide portion 231 is L2, where 9 cm≤L2≤11 cm. L2 may be, for example, 9 cm, 9.1 cm, 9.3 cm, 9.5 cm, 9.7 cm, 9.9 cm, 10 cm, 10.2 cm, 10.4 cm, 10.5 cm, 10.6 cm, 10.8 cm, or 11 cm, or may be other values in the above range, which is not limited in the present disclosure. Additionally/alternatively, along the second direction Y, a length of the second guide portion 232 is L3, where 5 cm≤L336 cm. L3 may be, for example, 9 cm, 9.1 cm, 9.3 cm, 9.5 cm, 9.7 cm, 9.9 cm, 10 cm, 10.2 cm, 10.4 cm, 10.5 cm, 10.6 cm, 10.8 cm, or 11 cm, or may be other values in the above range, which is not limited in the present disclosure.

If L2 is excessively small (e.g., less than 9 cm), a length of at least one of the first section 231a and the second section 231b along the second direction Y may be excessively small, causing at least one of the guiding effect and/or the limiting effect of the first guide portion 231 to fail to meet expectations. If L2 is excessively large (e.g., greater than 11 cm), the length of at least one of the first section 231a and the second section 231b along the second direction Y may be excessively large, causing a volume and a weight of the first guide portion 231 to increase, which may bring a burden to load-bearing capacity of the side plate 21. However, the guiding effect and/or limiting effect of the first guide portion 231 have/has not been improved.

Similarly, if L3 is excessively small (e.g., less than 5 cm), a length of at least one of the third section 232a and the fourth section 232b along the second direction Y may be excessively small, causing at least one of the guiding effect and/or the limiting effect of the second guide portion 232 to fail to meet expectations. If L3 is excessively large (e.g., greater than 6 cm), the length of at least one of the third section 232a and the fourth section 232b along the second direction Y may be excessively large, causing a volume and a weight of the second guide portion 232 to increase, which may bring a burden to the load-bearing capacity of the side plate 21. However, the guiding effect and/or limiting effect of the second guide portion 232 have/has not been improved.

Therefore, when the length L2 of the first guide portion 231 ranges from 9 cm to 11 cm, the first guide portion 231 can be ensured to have good guiding and limiting effects, the volume and the weight of the first guide portion 231 can be appropriately reduced, ensuring structural strength of the first guide portion 231. Additionally/alternatively, when the length L3 of the second guide portion 232 ranges from 5 cm to 6 cm, the second guide portion 232 can be ensured to have good guiding and limiting effects, the volume and the weight of the second guide portion 232 can be appropriately reduced, ensuring structural strength of the second guide portion 232.

In some embodiments, as shown in FIG. 6, a dimension of the first section 231a in the second direction Y is L4, and a dimension of the second section 231b in the second direction Y is L5, where 0.16≤L4:L5≤0.38. L4:L5 may be, for example, 0.16, 0.18, 0.2, 0.21, 0.23, 0.25, 0.27, 0.29, 0.3, 0.33, 0.35, 0.36, or 0.38, or may be other values in the above range, which is not limited in the present disclosure.

If L4:L5 is excessively small (e.g., less than 0.16), when a total length of the first guide portion 231 is fixed, the length LA of the first section 231a may be excessively small. As a result, the first section 231a cannot achieve the guiding effect. If L4:L5 is excessively large (e.g., greater than 0.38), when the total length of the first guide portion 231 is fixed, the length L4 of the first section 231a may be excessively large and the length L5 of the second section 231b may be excessively small. As a result, the limiting effect of the second section 231b does not meet expectations, and the battery pack 20 is prone to shaking in the first direction X. Therefore, when L4:L5 ranges from 0.16 to 0.38, the first section 231a can be ensured to have a good guiding effect, and at the same time, the second section 231b can also have a good limiting effect, helping improve mounting efficiency and mounting stability of the battery pack 20.

Since the dimension L3 of the second guide portion 232 is smaller than the dimension L2 of the first guide portion 231, to ensure that the second guide portion 232 has a good guiding effect, a dimension ratio of the third section 232a to the fourth section 232b should be slightly larger than a dimension ratio of the first section 231a to the second section 231b. In some embodiments, as shown in FIG. 7, a dimension of the third section 232a in the second direction Y is L6, and a dimension of the fourth section 232b in the second direction Y is L7, where 0.33≤L6:L7≤1. L6:L7 may be, for example, 0.33, 0.35, 0.4, 0.46, 0.5, 0.54, 0.58, 0.6, 0.65, 0.69, 0.7, 0.75, 0.8, 0.82, 0.8, 0.9, 0.95, or 1, or may be other values in the above range, which is not limited in the present disclosure.

If L6:L7 is excessively small (e.g., less than 0.33), when a total length of the second guide portion 232 is fixed, the length L6 of the third section 232a may be excessively small. As a result, the third section 232a cannot achieve the secondary guiding effect. If L6:L7 is excessively large (e.g., greater than 1), when the total length of the second guide portion 232 is fixed, the length L6 of the third section 232a may be excessively large and the length L7 of the fourth section 232b may be excessively small. As a result, the limiting effect of the fourth section 232b does not meet expectations, and the battery pack 20 is prone to shaking in the first direction X. Therefore, when L6:L7 ranges from 0.33 to 1, the third section 232a can be ensured to have a good guiding effect, and at the same time, the fourth section 232b can also have a good limiting effect, helping improve mounting efficiency and mounting stability of the battery pack 20.

In some embodiments, there is an angle α between an extension direction of the guide slope 233 and the first direction X, where 20°≤α≤30°. α may be, for example, 20°, 21°, 22°, 23°, 24°, 25°, 26°, 27°, 28°, 29°, or 30°, or may be other values in the above range, which is not limited in the present disclosure.

As shown in FIG. 6 and FIG. 7, the first section 231a and the third section 232a are each provided with the guide slope 233. When a is excessively small (e.g., less than 20°), an inclination angle of the guide slope 233 is excessively small. As a result, the length of the guide slope 233 in the second direction Y is excessively large, and the battery pack 20 is required to slide by a long distance along the guide slope 233 to achieve an accurate positioning effect, resulting in relatively low guide efficiency of the first section 231a and the third section 232a. Moreover, when the lengths of the first guide portion 231 and the second guide portion 232 are fixed, the lengths of the second section 231b and the fourth section 232b may be excessively small, the limiting effects of the second section 231b and the fourth section 232b on the battery pack 20 may be affected, and the battery pack 20 has a risk of shaking in the first direction X. When α is excessively large (e.g., greater than) 30°, the inclination angle of the guide slope 233 is excessively large, and the length of the guide slope 233 in the second direction Y is excessively small. As a result, the guiding effects of the first section 231a and the third section 232a are not obvious, which affects the mounting efficiency of the battery pack 20.

Therefore, when the angle α between an extension direction of the guide slope 233 and the first direction X ranges from 20° to 30°, the guiding effect of the guide portion 23 can be ensured, and the mounting stability of the battery pack can be improved to prevent shaking thereof in the first direction X during the transportation of the energy storage apparatus.

In some embodiments, along the first direction X, a width of the limiting section is W1, where 2 cm≤W1≤2.5 cm. W1 may be, for example, 2 cm, 2.05 cm, 2.1 cm, 2.15 cm, 2.2 cm, 2.25 cm, 2.3 cm, 2.35 cm, 2.4 cm, 2.45 cm, or 2.5 cm.

If W1 is excessively small (e.g., less than 2 cm), the limiting effect of the limiting section may not be obvious, and the battery pack 20 is prone to offset and shaking in the first direction X. If W1 is excessively large (e.g., greater than 2.5 cm), the width of the limiting section in the first direction X is excessively large, which easily causes friction with the side wall of the guide groove 201, leading to wear of the battery pack 20 and the guide portion 23 and affecting safety of the battery pack 20 and the service life of the guide portion 23. Therefore, when the width W1 of the limiting section ranges from 2 cm to 2.5 cm, the limiting portion can be ensured to have a good limiting effect, and unnecessary wear between the battery pack 20 and the limiting section can also be prevented, thereby improving the safety of the battery pack 20 and prolonging the service life of the battery pack 20 and the guide portion 23.

For example, since the second section 231b and the fourth section 232b are both limiting sections, and the widths of the second section 231b and the fourth section 232b are within a range of 2 cm to 2.5 cm, the widths of the second section 231b and the fourth section 232b may be equal, or the fourth section 232b may be slightly wider than the second section 231b, so that secondary limiting can be performed on the battery pack 20, to further improve the stability of the battery pack 20 and reduce a risk of shaking in the first direction X.

In some embodiments, the side plate 21 is further provided with a first bending portion 26, and the guide portion is fixedly connected to the side plate 21 through the first bending portion 26.

As shown in FIG. 6 and FIG. 7, the first guide portion 231 and the second guide portion 232 are connected to the side plate 21 through a first bending portion 26 respectively. When the energy storage apparatus bumps during the transportation or shakes during the hoisting, the battery pack 20 may move upwards along the third direction Z. As a result, the first guide portion 231 and/or the second guide portion 232 are/is subjected to an upward force along the third direction Z. In this case, the first bending portion 26 may deform synchronously with the first guide portion 231 and/or the second guide portion 232 to reduce an impact of deformation of the first guide portion 231 and/or the second guide portion 232 on the side plate 21.

Therefore, the arrangement of the first bending portion 26 can provide a certain deformation margin for the first guide portion 231 and the second guide portion 232 to prevent deformation of the side plate 21 under the driving of the first guide portion 231 and/or the second guide portion 232, thereby improving structural stability of the support member 2.

In addition, as shown in FIG. 6 and FIG. 7, the side plate 21 is further provided with a notch 212, and the first bending portion 26 is located in the notch 212. Moreover, along the second direction Y, there is a gap (not shown) between the first bending portion 26 and a side wall of the notch 212. The gap can provide a certain deformation space for the first bending portion 26 to deform in the second direction Y, preventing generation of large stress due to abutment of the first bending portion 26 against the side wall of the notch 212 and reducing a possibility of damages to the first bending portion 26 and the side plate 21.

In some embodiments, as shown in FIG. 4, the support member 2 further includes a limiting plate 27 extending along the third direction Z, the limiting plate 27 is located at the second end 25, and the limiting plate 27 is fixedly connected to both the bottom plate 22 and the side plate 21.

In such embodiments, the limiting plate 27 is located at an end of the support member 2 away from the cabinet door 105. That is, the limiting plate 27 can limit the battery pack 20 at a rear end of the battery pack 20 to control a placement depth of the battery pack 20. As shown in FIG. 3, most of the pipelines of the battery pack 20 are connected to a front end thereof. When the limiting plate 27 is provided, an excessively far distance between the front end of the battery pack 20 and the cabinet door 105 can be prevented, to facilitate the staff to inspect and maintain the battery pack 20, and detachment of the battery pack 20 from the battery rack 30 from the second end 25 due to an excessive pushing depth can also be prevented, improving placement stability and safety of the battery pack 20.

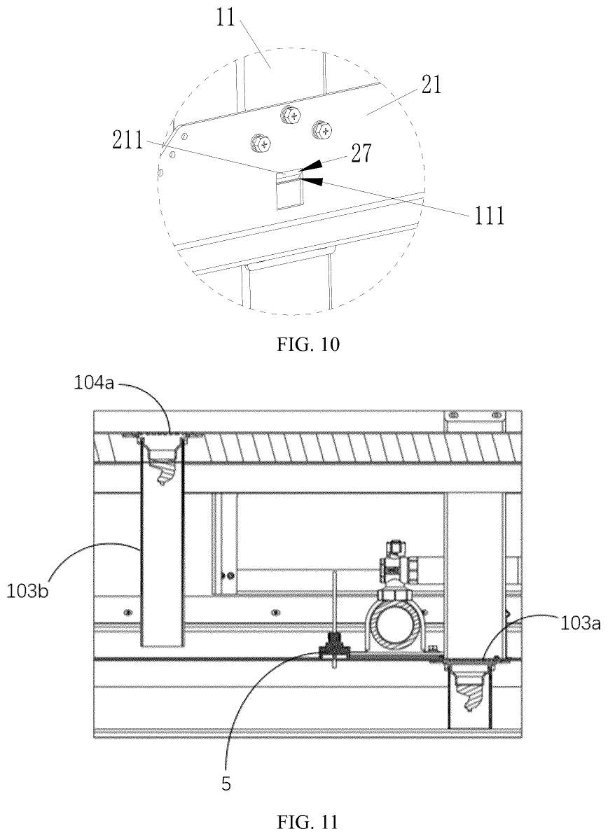

In some embodiments, as shown in FIG. 10, the longitudinal beam 11 is provided with an insertion hole 111, the side plate 21 is provided with a plug-in portion 211, and at least part of the plug-in portion 211 can extend into the insertion hole 111, to limit movement of the support member 2 along the third direction Z and/or the second direction Y.

As shown in FIG. 10, the side plate 21 and the longitudinal beam 11 are fixedly connected through a part such as a bolt. Once the bolt becomes loose or even detached, the mounting stability of the support member 2 may be affected and the bolt may even fall from the longitudinal beam 11, which may seriously affect mounting stability and safety of the battery pack 20. Therefore, in such embodiments, a fitting structure of the plug-in portion 211 and the insertion hole 111 is provided, the plug-in portion 211 extends into the insertion hole 111, and the insertion hole 111 may limit movement of the plug-in portion 211 in the second direction Y and/or the third direction Z, thereby preventing sliding of the support member 2 along the second direction Y and preventing shaking of the support member 2 along the third direction Z, which ensures good stability of connection between the support member 2 and the longitudinal beam 1.

In addition, as shown in FIG. 10, the side plate 21 is further provided with a second bending portion 28, and the plug-in portion 211 is fixedly connected to the side plate through the second bending portion 28. The second bending portion 28 can provide a certain deformation margin for the plug-in portion 211 to prevent deformation of the side plate 21 under the driving of the plug-in portion 211, thereby improving the structural stability of the support member 2. The second bending portion 28 is located in the insertion hole 111, and along the second direction Y, there is a gap (not shown) between the second bending portion 28 and a side wall of the insertion hole 111. The gap can provide a certain deformation space for the second bending portion 28 to deform in the second direction Y, preventing generation of large stress due to abutment of the second bending portion 28 against the side wall of the insertion hole 111 and reducing a possibility of damages to the second bending portion 28 and the side plate 21.

It is to be noted that in the above embodiments, the support member 2 may have an integrated structure. That is, the first bending portion 26, the guide portion 23, the second bending portion 28, the plug-in portion 211, the side plate 21, the bottom plate 22, and the limiting plate 27 may have an integrated structure formed by one-time stamping, or may have an integrated structure formed by secondary machining of a sheet through a process such as cutting or bending. In addition, the support member 2 may have a split structure. That is, the first bending portion 26, the guide portion 23, the second bending portion 28, the plug-in portion 211, the side plate 21, the bottom plate 22, and the limiting plate 27 may be fixedly connected by welding.

In the above embodiments, as shown in FIG. 8, the battery rack 30 further includes a reinforcing member 3, and the reinforcing member 3 is fixedly connected to both the longitudinal beam 11 and the bottom plate 22.

In such embodiments, the reinforcing member 3 may have a right-angled structure, with two right-angled sides fixed to the support member 2 and the longitudinal beam 11 respectively, which can play a role of supporting the support member 2 in the third direction Z and can also improve stability of the connection between the support member 2 and the longitudinal beam 11. The reinforcing member 3 may be fixed to the support member 2 and the longitudinal beam 11 by, for example, bolted connection or adhesive connection, which is not limited in the present disclosure.

The battery pack 20 inside the energy storage apparatus may generate heat during operation. Therefore, the energy storage apparatus generally implements liquid cooling by providing a liquid cooling assembly to maintain a normal operating temperature of the battery pack 20. Leakage of coolant may occur when the liquid cooling assembly operates. Therefore, the energy storage apparatus has to be provided with a drainage structure to prevent damages to the device inside the energy storage apparatus due to water accumulation inside the energy storage apparatus.

The liquid cooling assembly mainly includes a cooling plate and a cooling pipeline. The cooling pipeline includes a primary pipeline that supplies water to the box 10, a secondary pipeline that supplies water to the battery cluster, and a tertiary pipeline that supplies water to the battery pack.

In addition, as shown in FIG. 1 and FIG. 2, the box 10 further has a high-voltage compartment 103, and the high-voltage compartment 103 is provided with a high-voltage box 40. The high-voltage box 40 is a high-voltage circuit management module that connects the battery pack 20 and the PCS, and has functions such as voltage and current collection, contactor control and protection for the battery pack 20. Along the third direction Z, the high-voltage compartment 103 is provided below the battery compartment 102, and the two are separated by a partition 104, thereby facilitating wiring between the battery pack 20 and the high-voltage box 40.

In some embodiments, as shown in FIG. 11, the partition 104 has a first drain outlet 104a, the first drain outlet 104a is in communication with the battery compartment 102 and the high-voltage compartment 103, the high-voltage compartment 103 has a connecting pipe 103b, the connecting pipe 103b is in communication with the first drain outlet 104a, a bottom wall of the high-voltage compartment 103 has a second drain outlet 103a, and the second drain outlet 103a is in communication with the outside.

In such embodiments, as shown in FIG. 11, when the liquid cooling assembly configured to cool the battery pack 20 fails and leaks, leaked liquid may flow to the partition 104 and can further flow into the high-voltage compartment 103 through the first drain outlet 104a and then be discharged from the battery compartment 102 in time, thereby preventing damages to components such as the battery pack 20 caused by excessive accumulation of the leaked liquid in the battery compartment 102. The bottom wall of the high-voltage compartment 103 is provided with the second drain outlet 103a. When the leaked liquid flows into the high-voltage compartment 103 from the first drain outlet 104a, the leaked liquid can be discharged to the outside through the second drain outlet 103a. The high-voltage compartment 103 is provided with a connecting pipe 103b. A drainage pipe 32 is configured to guide water flowing out from the first drain outlet 104a, to prevent immersion of and damages to the high-voltage box 40 due to direct dripping of the water discharged from the first drain outlet 104a to the high-voltage box 40. Since the coolant is corrosive to some extent and cannot be discharged at will, in the prior art, cooling water may accumulate on a bottom wall of the battery compartment 102 and then be discharged uniformly according to regulations. However, the bottom wall of the battery compartment 102 is easily deformed under the weight, and excessive liquid accumulation may affect overall structural strength of the energy storage apparatus.

The energy storage apparatus provided in some embodiments of the present disclosure has a two-stage drainage structure. The coolant flowing to the bottom wall of the battery compartment 102 can further flow into the high-voltage compartment 103 through the first drain outlet 104a for storage and then be uniformly discharged through the second drain outlet 103a, which reduces a possibility of damages to the battery compartment 102 due to storage of the coolant.

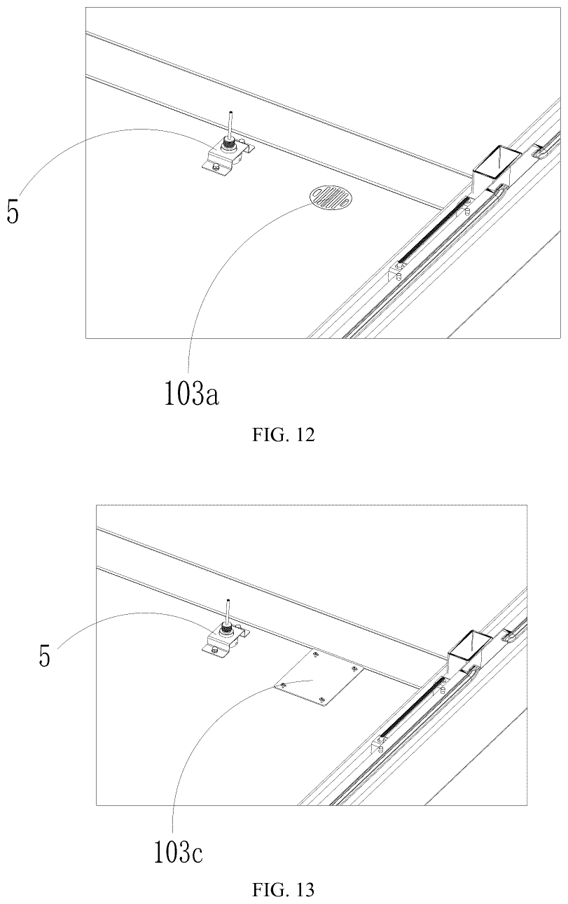

As shown in FIG. 12 and FIG. 13, in some embodiments, the second drain outlet 103a has a closing valve 103c, and the closing valve 103c is detachably mounted on the second drain outlet 103a.

The closing valve 103c is configured to control opening and closing of the second drain outlet 103a. When the energy storage apparatus operates normally, the closing valve 103c closes the second drain outlet 103a. After the liquid cooling assembly fails and leaks, the closing valve 103c can close the second drain outlet 103a, and the leaked liquid can be temporarily stored in the high-voltage compartment 103. If the leaked liquid is directly discharged to the outside, pollution may be caused. Therefore, when a manual operation meets a discharge condition, the closing valve 103c is opened to discharge the leaked liquid, which is collected for proper disposal. The closing valve 103c may be in a shape of a sheet and mounted on the bottom wall of the high-voltage compartment 103 to close the second drain outlet 103a to achieve a closing effect. After the closing valve 103c is removed, the second drain outlet 103a can drain water normally, or the closing valve 103c may be mounted inside the second drain outlet 103a provided that the second drain outlet 103a can be opened and closed.

In some embodiments, the partition 104 is made of a sheet and a core, the core is located between two sheets, the sheet is metal, and the core is rock wool.

The sheet may be metal such as stainless steel. The sheet is used to achieve support, protection, and waterproofing effects. When the liquid cooling assembly leaks, the liquid dripping on the partition 104 may not flow directly from the partition 104 to the high-voltage compartment 103, thereby preventing accidents caused by direct dripping of the liquid onto the high-voltage box 40 mounted in the high-voltage compartment 103. The partition 104 includes two layers of sheets. A core is arranged between the sheets. The core is rock wool. The rock wool is a man-made inorganic fiber made from basalt that is taken as a raw material and melted at a high temperature, which has high compressive strength and excellent fire resistance. When a device such as the high-voltage box 40 in the high-voltage compartment 103 catches fire due to short circuit or other reasons, the core can prevent spreading of the fire and reduce a possibility of fire catching of the battery pack inside the battery compartment 102, or when the battery pack in the battery compartment 102 catches fire, the core can also prevent spreading of the fire to the high-voltage compartment 103.

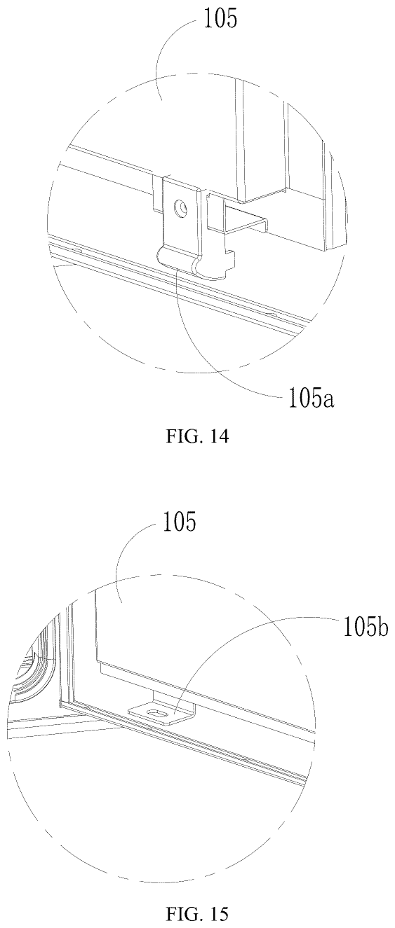

As shown in FIG. 2 and FIG. 14, in some embodiments, the energy storage apparatus has a plurality of cabinet doors 105. The plurality of cabinet doors 105 are rotatably fixed to the box 10. The cabinet doors 105 are configured to close the battery compartment 102 and the high-voltage compartment 103, and the cabinet doors 105 are configured to close the device compartment 101. Each of the cabinet doors 105 is provided with a door lifter 105a at the bottom, and the door lifter 105a has a guide surface.

The cabinet door 105 is generally mounted on the box 10 through a rotating shaft. The cabinet door 105 can rotate relative to the box 10 to open or close the battery compartment 102 and the high-voltage compartment 103, and is configured to close the device compartment 101. Due to a large self-weight of the cabinet door 105, frequent opening and closing of the door may cause the cabinet door 105 to deform, and the cabinet door 105 may be displaced relative to the box 10 along the height direction of the energy storage apparatus due to gravity. As a result, the cabinet door 105 can no longer be aligned with openings of the compartments, making it difficult to close the cabinet door 105. The cabinet door 105 provided in some embodiments of the present disclosure is provided with the door lifter 105a. The door lifter 105a is located on a side of the cabinet door 105 close to the box 10, and the door lifter 105a has a guide surface. The guide surface may be an inclined surface or a curved surface. When the cabinet door 105 is required to be closed, the door lifter 105a first abuts against an edge of the box 10 and slides. Even if the cabinet door 105 is displaced or deformed, the cabinet door 105 can also be closed smoothly under the guidance of the door lifter 105a.

As shown in FIG. 15, in some embodiments, the cabinet door 105 has a hook 105b, the hook 105b has a hanging hole, and the hanging hole can fit a hanging rod to limit closing of the cabinet door 105.

The cabinet door 105 is provided with the hook 105b at the bottom. The hook 105b is provided in a shape of L. The hook 105b has one end connected to the cabinet door 105 and the other end extending towards a direction close to the box 10 and provided with a hanging hole. The hanging rod can be mounted on the hook 105b through the hanging hole. When maintenance of the energy storage apparatus is required, the cabinet door 105 is required to be opened and the hanging rod is mounted in the hanging hole. When the cabinet door 105 rotates due to misoperation or other reasons, the hanging rod abuts against the box 10, so that the cabinet door 105 cannot be closed and remains open, reducing a possibility of accidents caused by accidental closing of the cabinet door 105.

As shown in FIG. 11 and FIG. 12, in some embodiments, the energy storage apparatus includes a plurality of liquid sensors 5, and the plurality of liquid sensors 5 are respectively mounted on the partition 104 and the bottom wall of the high-voltage compartment 103.

The liquid sensor 5 is configured to detect whether there is water accumulating inside the battery compartment 102 and the high-voltage compartment 103. The liquid sensor 5 has an inductive probe. The inductive probe can monitor liquid level changes. When the inductive probe detects a liquid level, sensed data may be converted into electrical signals and transmitted to another device for further processing. For example, an alarm may be issued to remind the staff to perform inspection and discharge. The liquid sensor 5 mounted on the bottom wall of the high-voltage compartment 103 is 0 to 2 mm away from the bottom wall. When the coolant accumulates to a certain depth in the high-voltage compartment 103, the staff can be promptly reminded to operate to prevent immersion of and damages to the device due to excessive accumulation of water.

As shown in FIG. 11, in some embodiments, the liquid sensor 5 in the high-voltage compartment 103 is located between the connecting pipe 103b and the second drain outlet 103a.

The first drain outlet 104a is located at a corner of the partition 104, and the components in the battery compartment 102 may not block the first drain outlet 104a. The second drain outlet 103a is located near a corner of the bottom wall of the high-voltage compartment 103, and the components in the high-voltage compartment may not block the second drain outlet 103a. The first drain outlet 104a and the connecting pipe 103b are staggered from the second drain outlet 103a. That is, projections of the first drain outlet 104a and the second drain outlet 103a in a height direction of the energy storage apparatus do not overlap with each other. The first drain outlet 104a and the second drain outlet 103a may be arranged at diagonal positions. When the coolant leaks, the partition 104 can first collect a certain amount of coolant, and then the coolant flows into the high-voltage compartment 103 from the first drain outlet 104a, preventing excessive pressure on the high-voltage compartment 103 due to direct entry of all the coolant into the high-voltage compartment 103. The liquid sensor 5 is located between the first drain outlet 104a and the second drain outlet 103a, the coolant flowing out from the first drain outlet 104a may not drip directly onto the liquid sensor 5 through the connecting pipe 103b, thereby reducing a possibility of misjudgment. When the coolant accumulates to a certain height in the high-voltage compartment 103, the liquid sensor 5 may be triggered, improving accuracy of monitoring. As shown in FIG. 2, in some embodiments, an inner wall of the high-voltage compartment 103 has a plurality of high-voltage box frames, the plurality of high-voltage box frames are respectively located on two sides of the high-voltage compartment 103, the high-voltage box frames are not in contact with the bottom wall of the high-voltage compartment 103, and the high-voltage box frames are configured to mount the high-voltage box 40.

The high-voltage box frame has one end fixed to a side wall of the high-voltage compartment 103 and the other end extending towards the inside of the high-voltage compartment 103. The extending portion is configured to support the high-voltage box 40. There is a preset distance between the high-voltage box frame and the bottom wall of the high-voltage compartment 103. When a cooling apparatus fails and leaks, water may accumulate in the high-voltage compartment 103. The high-voltage box 40 placed on the high-voltage box frame may be kept at a certain distance from the bottom wall of the high-voltage compartment 103, reducing a possibility of immersion of and damages to the high-voltage box 40.

The battery pack 20 and the high-voltage box 40 are connected through a wire harness. Since the partition 104 is provided between the battery compartment 102 and the high-voltage compartment 103, the wire harness connected to the battery pack 20 is required to pass through the partition 104 to be connected to the high-voltage box 40. In addition, the liquid cooling pipeline extending from the battery compartment 102 to the high-voltage compartment 103 is also required to pass through the partition 104.

A large through slot is provided on the partition of the existing energy storage apparatus, for the wire harness and the liquid cooling pipeline to pass through. However, once the high-voltage box 40 catches fire, flames may spread into the battery compartment 102 through the through slot, ignite the battery pack 20, and even cause an explosion, causing safety hazards.

In some embodiments, in the present disclosure, a fireproof member 4 is provided at the through slot of the partition 104. The fireproof member 4 partially blocks the through slot, thereby preventing spreading of the flame from the high-voltage compartment 103 to the battery compartment 102 or from the battery compartment 102 to the high-voltage compartment 103, and improving safety of the energy storage apparatus.

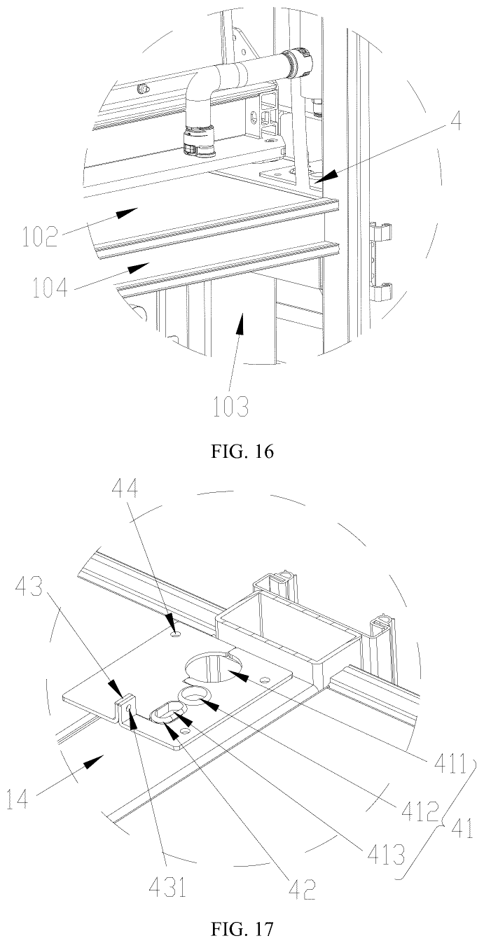

As shown in FIG. 16 and FIG. 17, the fireproof member 4 is configured to be arranged on the partition 104 between the battery compartment 102 and the high-voltage compartment 103 of the energy storage apparatus, and the fireproof member 4 is provided with a communication hole 41. The communication hole 41 is configured to allow the wire harness and/or the pipeline of the battery compartment 102 to extend into the high-voltage compartment 103. Since a size of the communication hole 41 matches that of the wire harness or pipeline, the fireproof member 4 reduces a communication area between the battery compartment 102 and the high-voltage compartment 103 and improves sealing performance between the battery compartment 102 and the high-voltage compartment 103, so that the flames are less likely to spread from the high-voltage compartment 103 to the battery compartment 102 or from the battery compartment 102 to the high-voltage compartment 103, thereby improving the safety of the energy storage apparatus.

For example, the communication hole 41 is in a shape of a circle or an oval. Cross sections of the wire harness and the pipeline are generally in a shape of a circle or an oval. Therefore, the communication hole 41 in a shape of a circle or an oval can better match the wire harness or pipeline.

For example, the fireproof member 4 is made of a galvanized sheet. The galvanized sheet has good heat resistance and corrosion resistance, and has high strength and stiffness. Therefore, the fireproof member 4 made of the galvanized sheet has a better effect in hindering the spreading of the flames, is not easily damaged, and has a long service life. It may be understood that the fireproof member 4 may alternatively be made of other high-temperature resistant fireproof materials.

In some embodiments, as shown in FIG. 17, the communication hole 41 includes a first through hole 411, a second through hole 412, and a third through hole 413, the first through hole 411 is configured to allow a liquid cooling pipeline to pass through, the second through hole 412 is configured to allow a communication wire harness to pass through, and the third through hole 413 is configured to allow a power wire harness to pass through.

In such embodiments, as shown in FIG. 17, the fireproof member 4 may be provided with a plurality of communication holes 41, thereby matching the liquid cooling pipeline, the communication wire harness, the power wire harness, and the like. For example, a size of the first through hole 411 matches that of the liquid cooling pipeline, so that the liquid cooling pipeline can pass therethrough smoothly. A size of the second through hole 412 matches that of the communication wire harness, so that the communication wire harness can pass therethrough smoothly. A size of the third through hole 413 matches that of the power wire harness, so that the power wire harness can pass therethrough smoothly.

In addition, the plurality of communication holes 41 provided on the fireproof member 4 can further classify and bundle the wire harnesses, making the wire harnesses more orderly and convenient for maintenance by the staff.

Further, as shown in FIG. 17, centers of the first through hole 411, the second through hole 412, and the third through hole 413 are not in a straight line, so that the arrangement of the plurality of communication holes 41 on the fireproof member 4 is more reasonable, and area utilization of the fireproof member 4 is higher.

At the same time, in order to improve space utilization of the box 10 and realize miniaturization of the energy storage apparatus, structures such as the liquid cooling pipeline, the communication wire harness, and the power wire harness are required to be reasonably arranged, so that the liquid cooling pipeline, the communication wire harness, and the power wire harness are generally not laid out in a straight line. Therefore, the first through hole 411, the second through hole 412, and the third through hole 413 whose centers are not in a straight line can match positions of the liquid cooling pipeline, the communication wire harness, and the power wire harness.

Furthermore, as shown in FIG. 17, a sealing member 42 may be provided in the communication hole 41, and the sealing member 42 is located between the communication hole 41 and the wire harness or between the communication hole 41 and the pipeline. The sealing member 42 can seal a region between the communication hole 41 and the wire harness or a region between the communication hole 41 and the pipeline, further reducing the communication area between the battery compartment 102 and the high-voltage compartment 103, improving sealing performance between the battery compartment 102 and the high-voltage compartment 103, and improving safety of the energy storage apparatus.

The sealing member 42 may be made of a non-combustible fireproof material.

In some embodiments, as shown in FIG. 17, the fireproof member 4 includes a plurality of plates, the plates are provided with grooves, and when the plurality of plates are spliced, the grooves are enclosed to form the communication hole 41.

In such embodiments, as shown in FIG. 17, the communication hole 41 is formed by splicing the grooves in the plurality of plates. Therefore, when the wire harness or pipeline is assembled with the fireproof member 4, the plurality of plates may be assembled with the wire harness or pipeline in sequence, thereby reducing difficulty of assembling the wire harness or pipeline with the fireproof member 4 and improving assembly efficiency.

For example, as shown in FIG. 17, the fireproof member 4 includes a first plate and a second plate, the first plate and the second plate are each provided with a protruding portion 43, and the protruding portion 43 is provided with a first mounting hole 431. When the first plate and the second plate are spliced, the two protruding portions 43 abut against each other, and a first connecting member passes through the two first mounting holes 431.

In such embodiments, as shown in FIG. 17, the first connecting member passes through the first mounting holes 431 in the two protruding portions 43, so that the first plate and the second plate are firmly and reliably connected. The first connecting member may be a fastener such as a screw or a bolt. In addition, the first plate and the second plate may alternatively be connected in a manner such as bonding and snapping.

In some embodiments, as shown in FIG. 17, the fireproof member 4 is provided with a plurality of second mounting holes 44 along a circumferential direction, and a second connecting member passes through the second mounting holes 44 and is connected to the partition 104.

In such embodiments, as shown in FIG. 17, the second connecting member passes through the second mounting holes 44 and is connected to the partition 104, so that the fireproof member 4 and the partition 104 are firmly and reliably connected. The second connecting member may be a fastener such as a screw or a bolt. In addition, the fireproof member 4 and the partition 104 may alternatively be connected in a manner such as bonding and snapping.

The above descriptions are only preferred embodiments of the present disclosure and are not intended to limit the present disclosure. For those skilled in the art, the present disclosure may have various modifications and changes. Any modifications, equivalent replacements, improvements, and the like made within the spirit and principles of the present disclosure shall be included in the protection scope of the present disclosure.

What is claimed is:

1. An energy storage apparatus, comprising:
a box (10);
a battery pack (20) mounted in the box (10), wherein along a first direction, each of two sides of the battery pack (20) is provided with a guide groove (201); and
a battery rack (30), configured to place the battery pack (20), and comprising a rack body (1) and a support member (2), wherein, along the first direction, each of two sides of the rack body (1) is connected to the support member (2) respectively;
wherein the support member (2) comprises a side plate (21) and a bottom plate (22) that are fixedly connected to each other, the bottom plate (22) is configured to bear the battery pack (20), the side plate (21) is provided with a guide portion (23), and when the battery pack (20) moves along a second direction on the bottom plate (22), at least part of the guide portion (23) is capable of extending into the guide groove (201) to limit movement of the battery pack (20) in the first direction; and
the second direction is perpendicular to the first direction.

2. The energy storage apparatus according to claim 1, wherein
the support member (2) comprises a first end (24) and a second end (25) that are oppositely arranged along the second direction, and along a direction from the first end (24) to the second end (25), the guide portion (23) comprises a guide section and a limiting section arranged in sequence; and
along the direction from the first end (24) to the second end (25), a dimension of the guide section in the first direction gradually increases.

3. The energy storage apparatus according to claim 2, wherein
along the first direction, a guide slope (233) is provided at a side of the guide section away from the side plate (21), and an angle α is formed between an extension direction of the guide slope (233) and the first direction, where 20°≤α≤30°; and/or
along the first direction, a width of the limiting section is defined as W1, where 2 cm≤W1≤2.5 cm.

4. The energy storage apparatus according to claim 2, wherein
the guide portion (23) comprises a first guide portion (231) and a second guide portion (232), and
the first guide portion (231) and the second guide portion (232) are spaced apart along the second direction.

5. The energy storage apparatus according to claim 4, wherein
along the second direction, a distance between the first guide portion (231) and the second guide portion (232) is defined as L1, where 50 cm≤L1≤55 cm; and/or
along the second direction, a length of the first guide portion (231) is defined as L2, where 9 cm≤L2≤11 cm; and/or
along the second direction, a length of the second guide portion (232) is defined as L3, where 5 cm≤L3≤36 cm.

6. The energy storage apparatus according to claim 4, wherein
along the direction from the first end (24) to the second end (25), the first guide portion (231) comprises a first section (231a) and a second section (231b) arranged in sequence, the first section (231a) is the guide section, and the second section (231b) is the limiting section;
a dimension of the first section (231a) in the second direction is LA, and a dimension of the second section (231b) in the second direction is L5, where 0.16≤L4:L5≤0.38; and/or
along the direction from the first end (24) to the second end (25), the second guide portion (232) comprises a third section (232a) and a fourth section (232b) arranged in sequence, the third section (232a) is the guide section, and the fourth section (232b) is the limiting section; and
a dimension of the third section (232a) in the second direction is defined as L6, and a dimension of the fourth section (232b) in the second direction is defined as L7, where 0.33≤L6:L7≤1.

7. The energy storage apparatus according to claim 2, wherein
the support member (2) further comprises a limiting plate (27) extending along a third direction, the limiting plate (27) is located at the second end (25) and fixedly connected to the bottom plate (22) and the side plate (21); and
the third direction is perpendicular to the first direction and the second direction.

8. The energy storage apparatus according to claim 7, wherein
the rack body (1) comprises a longitudinal beam (11) extending along the third direction, and the side plate (21) is fixedly connected to the longitudinal beam (11); and along the third direction, a plurality of support members (2) are spaced apart on the longitudinal beam (11); and
the longitudinal beam (11) is provided with an insertion hole (111), the side plate (21) is provided with a plug-in portion (211), and at least part of the plug-in portion (211) is capable of extending into the insertion hole (111), to limit movement of the support member (2) along the third direction and/or the second direction.

9. The energy storage apparatus according to claim 1, wherein
the box (10) has a battery compartment (102), a high-voltage compartment (103) and a partition (104), the partition (104) is located between the battery compartment (102) and the high-voltage compartment (103) and has a first drain outlet (10), the first drain outlet (104a) communicates with the battery compartment (102) and the high-voltage compartment (103), and
wherein the high-voltage compartment (103) has a connecting pipe (103b), the connecting pipe (103b) is in communication with the first drain outlet (104a), a bottom wall of the high-voltage compartment (103) has a second drain outlet (103a), and the second drain outlet (103a) communicates with outside.

10. The energy storage apparatus according to claim 9, wherein
the second drain outlet (103a) has a closing valve (103c) detachably mounted on the second drain outlet (103a).

11. The energy storage apparatus according to claim 9, wherein
the partition (104) is made of a sheet and a core, wherein the core is arranged between two sheets, the sheet is made of a metal, and the core is rock wool.

12. The energy storage apparatus according to claim 9, wherein
the energy storage apparatus has cabinet doors (105), the cabinet doors (105) are rotatably fixed to the box (10), the cabinet doors (105) are configured to close the battery compartment (102) and the high-voltage compartment (103), wherein
each of the cabinet doors (105) is provided with a door lifter (105a) at the bottom, and the door lifter (105a) has a guide surface.

13. The energy storage apparatus according to claim 12, wherein
each of the cabinet door (105) has a hook (105b), the hook (105b) has a hanging hole, and the hanging hole is capable of fitting a hanging rod to limit closing of the cabinet door (105).

14. The energy storage apparatus according to claim 9, comprising a plurality of liquid sensors (5), the plurality of liquid sensors (5) is respectively mounted on the partition (104) and the bottom wall of the high-voltage compartment (103); and
the plurality of liquid sensors (5) in the high-voltage compartment (103) are located between the connecting pipe (103b) and the second drain outlet (103a).

15. The energy storage apparatus according to claim 9, wherein
an inner wall of the high-voltage compartment (103) has a plurality of high-voltage box frames respectively located on two sides of the high-voltage compartment (103), the plurality of high-voltage box frames are not in contact with the bottom wall of the high-voltage compartment (103), and the plurality of high-voltage box frames are configured to mount a high-voltage box (40).

16. The energy storage apparatus according to claim 1, wherein
the box (10) has a battery compartment (102), a high-voltage compartment (103), and a partition (104), wherein
the partition (104) is located between the battery compartment (102) and the high-voltage compartment (103), and is provided with a fireproof member (4), the fireproof member (4) is provided with a communication hole (41), a wire harness and/or a pipeline of the battery compartment (102) are capable of extending into the high-voltage compartment (103) through the communication hole (41).

17. The energy storage apparatus according to claim 16, wherein
the communication hole (41) comprises a first through hole (411), a second through hole (412) and a third through hole (413), wherein
the first through hole (411) is configured to allow a liquid cooling pipeline to pass through, the second through hole (412) is configured to allow a communication wire harness to pass through, and the third through hole (413) is configured to allow a power wire harness to pass through.

18. The energy storage apparatus according to claim 16, wherein
centers of the first through hole (411), the second through hole (412), and the third through hole (413) are not arranged in a straight line.

19. The energy storage apparatus according to claim 16, wherein
the fireproof member (4) comprises a plurality of plates, the plates are provided with grooves, and when the plurality of plates are spliced, the grooves are enclosed to form the communication hole (41).

20. The energy storage apparatus according to claim 19, wherein
the fireproof member (4) comprises a first plate and a second plate, each of the first plate and the second plate is provided with a protruding portion (43), the protruding portion (43) is provided with a first mounting hole (431); and
when the first plate and the second plate are spliced, the two protruding portions (43) abut against each other, and a first connecting member passes through two first mounting holes (431).
